(19) United States
(12) Patent Application Publication
(10) Pub. No.: US 2026/0244985 A1
(43) Pub. Date: Aug. 20, 2026

(54) STATEFUL TRAINING OF MACHINE LEARNING MODELS IN WIRELESS NETWORKING

(71) Applicant: Nokia Technologies Oy, Espoo (FI)

(72) Inventors: Ahmad MASRI, Tampere (FI); Jian SONG, Massy (FR); István Zsolt KOVÁCS, Aalborg (DK); Afef FEKI, Massy (FR)

(21) Appl. No.: 19/161,506

(22) PCT Filed: Feb. 7, 2024
(86) PCT No.: PCT/EP2024/052962

§ 371 Date: Sep. 2, 2025

(30) Foreign Application Priority Data
Mar. 8, 2023 (GB) 2303348.3

(51) Int. Cl. G06N 20/00

(52) U.S. Cl. CPC G06N 20/00

(57) ABSTRACT

There is provided a user equipment apparatus that includes at least one processor and at least one memory storing instructions. The instructions, when executed by the at least one processor, cause the user equipment apparatus at least to: access a usable machine learning (ML) model; receive, from a network apparatus, a freeze-to-adaptive ratio value; determine, based on the freeze-to-adaptive ratio, a frozen portion of the current ML model to not train and an adaptive portion of the usable ML model to train; access a performance measure for the usable ML model; retrain the adaptive portion of the usable ML model to provide a retrained ML model; determine a performance measure for the retrained ML model; and select one of the retrained ML model or the usable ML model based on the performance measure of the usable ML model and the performance measure of the retrained ML model.

WO

### FIELD

Various example embodiments relate generally to wireless networking and, more particularly, to stateful training of machine learning models in wireless networking.

### BACKGROUND

Wireless networking provides significant advantages for user mobility. A user's ability to remain connected while on the move provides advantages not only for the user, but also provides greater efficiency and productivity for society as a whole. As user expectations for connection reliability, data speed, and device battery life, become more demanding, technology for wireless networking must also keep pace with such expectations. Accordingly, there is continuing interest in improving wireless networking technology.

### SUMMARY

In accordance with aspects of the disclosure, a user equipment apparatus includes at least one processor and at least one memory storing instructions. The instructions, when executed by the at least one processor, cause the user equipment apparatus at least to: access a usable machine learning (ML) model; receive, from a network apparatus, a freeze-to-adaptive ratio value; determine, based on the freeze-to-adaptive ratio, a frozen portion of the current ML model to not train and an adaptive portion of the usable ML model to train; access a performance measure for the usable ML model; retrain the adaptive portion of the usable ML model to provide a retrained ML model; determine a performance measure for the retrained ML model; and select one of the retrained ML model or the usable ML model based on the performance measure of the usable ML model and the performance measure of the retrained ML model.

In aspects of the user equipment apparatus, the instructions, when executed by the at least one processor, may further cause the user equipment apparatus at least to: receive, from a network apparatus, an acceptance offset value; and offset the performance measure for the retrained ML model by the acceptance offset value to generate an offset performance measure for the retained ML model.

In aspects of the user equipment apparatus, the instructions, when executed by the at least one processor, may further cause the user equipment apparatus at least to: in case the offset performance measure for the retrained ML model is greater than or equal to the performance measure for the usable ML model, transmit to the network apparatus an indication of acceptable performance of the retrained ML model.

In aspects of the user equipment apparatus, the indication of acceptable performance of the retrained ML model may be transmitted in a case where the performance measure for the retrained ML model is less than the performance measure for the usable ML model by less than the acceptance offset value.

In aspects of the user equipment apparatus, the instructions, when executed by the at least one processor, may further cause the user equipment apparatus at least to: in case the offset performance measure for the retrained ML model is less than the performance measure for the usable ML model, transmit to the network apparatus an indication of unacceptable performance of the retrained ML model.

In aspects of the user equipment apparatus, the instructions, when executed by the at least one processor, may further cause the user equipment apparatus at least to: prior to retraining the adaptive portion of the usable ML model, generate a backup of the adaptive portion of the usable ML model.

In aspects of the user equipment apparatus, the instructions, when executed by the at least one processor, may further cause the user equipment apparatus at least to: in response to a request from the network apparatus, restore the adaptive portion of the usable ML model using the backup of the adaptive portion of the ML model.

In aspects of the user equipment apparatus, the instructions, when executed by the at least one processor, may further cause the user equipment apparatus at least to: receive, from the network apparatus, at least an adjusted freeze-to-adaptive ratio; and retrain an adjusted adaptive portion of the usable ML model based on the adjusted freeze-to-adaptive ratio.

In accordance with aspects of the disclosure, a method includes: accessing a usable machine learning (ML) model; receiving, from a network apparatus, a freeze-to-adaptive ratio value; determining, based on the freeze-to-adaptive ratio, a frozen portion of the usable ML model to not train and an adaptive portion of the usable ML model to train; accessing a performance measure for the usable ML model; retraining the adaptive portion of the usable ML model to provide a retrained ML model; determining a performance measure for the retrained ML model; and selecting one of the retrained ML model or the usable ML model based on comparing the performance measure of the usable ML model and the performance measure of the retrained ML model.

In aspects of the method, the method further includes: receiving, from a network apparatus, an acceptance offset value; and offsetting the performance measure for the retrained ML model by the acceptance offset value to generate an offset performance measure for the retained ML model.

In aspects of the method, the method further includes: in case the offset performance measure for the retrained ML model is greater than or equal to the performance measure for the usable ML model, transmitting to the network apparatus an indication of acceptable performance of the retrained ML model.

In aspects of the method, the indication of acceptable performance of the retrained ML model is transmitted in a case where the performance measure for the retrained ML model is less than the performance measure for the usable ML model by less than the acceptance offset value.

In aspects of the method, the method further includes: in case the offset performance measure for the retrained ML model is less than the performance measure for the usable ML model, transmitting to the network apparatus an indication of unacceptable performance of the retrained ML model.

In aspects of the method, the method further includes: prior to retraining the adaptive portion of the usable ML model, generating a backup of the adaptive portion of the usable ML model.

In aspects of the method, the method further includes: in response to a request from the network apparatus, restoring the adaptive portion of the usable ML model using the backup of the adaptive portion of the ML model.

In aspects of the method, the method further includes: receiving from the network apparatus at least an adjusted freeze-to-adaptive ratio; and retraining an adjusted adaptive portion of the usable ML model based on the adjusted freeze-to-adaptive ratio.

In accordance with aspects of the disclosure, a network apparatus includes at least one processor and at least one memory storing instructions. The instructions, when executed by the at least one processor, cause the network apparatus at least to: access a usable machine learning (ML) model, where the usable ML model includes a frozen portion of the usable ML model to not train and an adaptive portion of the usable ML model to train; generate a backup of the adaptive portion of the usable ML model; retrain the adaptive portion of the usable ML model to provide a retrained adaptive portion; and transmit parameters of the retrained adaptive portion to a user equipment apparatus for use by the user equipment apparatus.

In aspects of the network apparatus, the instructions, when executed by the at least one processor, further cause the network apparatus at least to: receive, from the user equipment apparatus, a performance measure indicating performance of the retrained adaptive portion; and determine whether or not to restore the backup of the adaptive portion of the usable ML model based on the performance measure indicating performance of the retrained adaptive portion.

In aspects of the network apparatus, the instructions, when executed by the at least one processor, further cause the network apparatus at least to: transmit, to the user equipment apparatus, the freeze-to-adaptive ratio to enable the user equipment apparatus to generate, at the user equipment apparatus, a local backup of the adaptive portion of the usable ML model.

In aspects of the network apparatus, the instructions, when executed by the at least one processor, further cause the network apparatus at least to, in case of determining to restore the backup of the adaptive portion of the usable ML model: restore the backup of the adaptive portion of the usable ML model; and transmit, to the user equipment apparatus, an instruction to restore, at the user equipment apparatus, the local backup of the adaptive portion of the usable ML model.

In aspects of the network apparatus, 21. The network apparatus of claim 19, wherein the instructions, when executed by the at least one processor, further cause the network apparatus at least to, in case of determining not to restore the backup of the adaptive portion of the usable ML model: delete the backup of the adaptive portion of the usable ML model; generate a backup of the retrained adaptive portion; and transmit, to the user equipment apparatus, an instruction to, at the user equipment apparatus, delete the local backup of the adaptive portion of the usable ML model and create a local backup of the retrained adaptive portion.

According to some aspects, there is provided the subject matter of the independent claims. Some further aspects are defined in the dependent claims.

### BRIEF DESCRIPTION OF THE DRAWINGS

Some example embodiments will now be described with reference to the accompanying drawings.

FIG. 1 is a diagram of an example embodiment of wireless networking between a network system and a user equipment (UE) apparatus, according to one illustrated aspect of the disclosure;

FIG. 2 illustrates an example embodiment of components of a user equipment apparatus or of a network apparatus, according to one illustrated aspect of the disclosure;

FIG. 3 illustrates a diagram of an example machine learning model, according to one illustrated aspect of the disclosure;

FIGS. 4A and 4B illustrate a flow diagram an example embodiment of a UE side machine learning operation, according to one illustrated aspect of the disclosure; and

FIGS. 5A and 5B illustrate a flow diagram of an example embodiment of network side machine learning operation, according to one illustrated aspect of the disclosure.

### DETAILED DESCRIPTION

In the following description, certain specific details are set forth in order to provide a thorough understanding of disclosed aspects. However, one skilled in the relevant art will recognize that aspects may be practiced without one or more of these specific details or with other methods, components, materials, etc. In other instances, well-known structures associated with transmitters, receivers, or transceivers have not been shown or described in detail to avoid unnecessarily obscuring descriptions of the aspects.

Reference throughout this specification to “one aspect” or “an aspect” means that a particular feature, structure, or characteristic described in connection with the aspect is included in at least one aspect. Thus, the appearances of the phrases “in one aspect” or “in an aspect” in various places throughout this specification are not necessarily all referring to the same aspect. Furthermore, the particular features, structures, or characteristics may be combined in any suitable manner in one or more aspects.

Embodiments described in the present disclosure may be implemented in wireless networking apparatuses, such as, without limitation, apparatuses utilizing Worldwide Interoperability for Microwave Access (WiMAX), Global System for Mobile communications (GSM, 2G), GSM EDGE radio access Network (GERAN), General Packet Radio Service (GRPS), Universal Mobile Telecommunication System (UMTS, 3G) based on basic wideband-code division multiple access (W-CDMA), high-speed packet access (HSPA), Long Term Evolution (LTE), LTE-Advanced, enhanced LTE (eLTE), 5G New Radio (5G NR), 5G Advanced, and 802.11ax (Wi-Fi 6), among other wireless networking systems. The term ‘eLTE’ here denotes the LTE evolution that connects to a 5G core. LTE is also known as evolved UMTS terrestrial radio access (EUTRA) or as evolved UMTS terrestrial radio access network (EUTRAN).

Aspects of the present disclosure relate to stateful training of machine learning models in wireless networking. Aspects of the present disclosure provide various advantages, including improving performance of machine learning models while preserving power in wireless networking apparatuses.

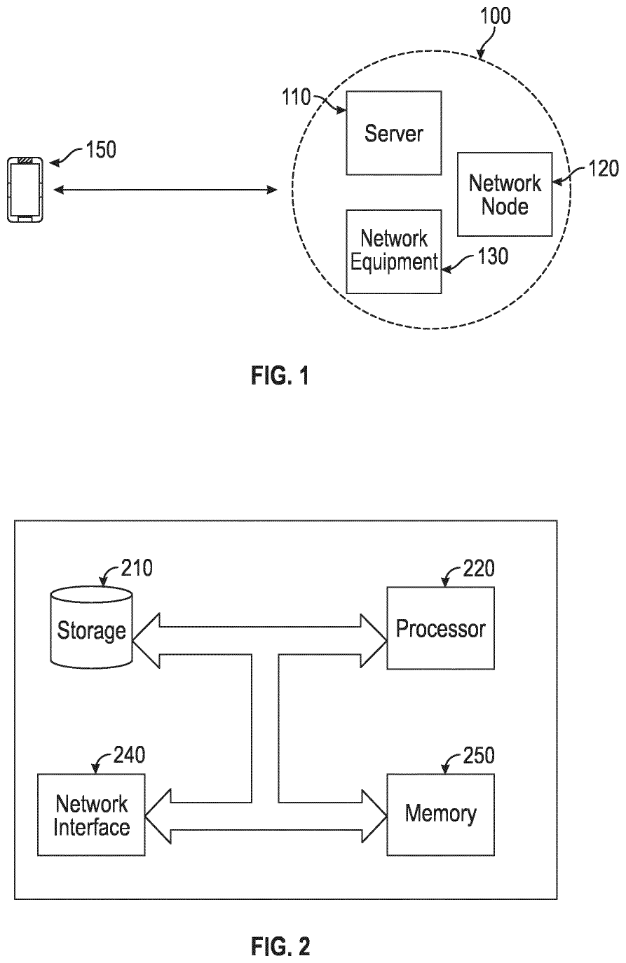

FIG. 1 is a diagram depicting an example of wireless networking between a network system 100 and a user equipment apparatus (UE) 150. The network system 100, for example, may include one or more network nodes 120, one or more servers 110, and/or one or more network equipment 130 (e.g., test equipment). As used herein, the term “network apparatus” may refer to any component of the network system 100, such as the server 110, the network node 120, the network equipment 130, any component(s) of the foregoing, and/or any other component(s) of the network system 100. Examples of network apparatuses include, without limitation, apparatuses implementing 5G NR and apparatuses implementing Wi-Fi 6, among others. The present disclosure describes embodiments related to 5G NR and embodiments that involve aspects defined by 3rd Generation Partnership Project (3GPP). With respect to such embodiments, the network node 120 may be a gNodeB (also known as gNB). However, it is contemplated that embodiments relating to other wireless networking technologies are encompassed within the scope of the present disclosure.

In radio communications, a node may be implemented, at least partly, by a centralized unit, CU, (e.g., server or host), that is operationally coupled to one or more distributed units, DU, (e.g., a radio head). In embodiments, it is possible that node operations may be distributed among multiple centralized units (e.g., servers or hosts). In embodiments, a network node in 5G wireless networking may be implemented based on a so-called CU-DU split. In embodiments, a processing task may be performed in either the CU or the DU, and the shifting of responsibility between the CU and the DU may be configurable according to a particular implementation.

With continuing reference to FIG. 1, in the example of a 5G NR network, the network system 100 provides a cell, which defines a coverage area of the network system 100. As described above, the network system 100 may include a gNB of a 5G NR network or may be any other apparatus configured to control radio communication and manage radio resources within a cell. As used herein, the term “resource” may refer to radio resources, such as a physical resource block (PRB), a radio frame, a subframe, a time slot, a sub-band, a frequency region, a sub-carrier, a beam, etc. In embodiments, the network node apparatus 120 may be called a base station.

The UE 150 may include, but is not limited to, a smartphone, a tablet, portable computers, vehicle-mounted wireless terminal devices, an Internet of Things (IoT) device, and/or a watch or other wearable device, among others. The network system 100 may provide the UE 150 with wireless access to other networks, such as the Internet. The wireless access may include downlink (DL) communication from the network system 100 to the UE 150 and uplink (UL) communication from the UE 150 to the network system 100. As used herein, the terms “transmission” and/or “reception” may refer to, respectively, wirelessly transmitting and/or receiving via a wireless propagation channel on radio resources. There may be other UE in the cell, and each of them may be serviced by the same or by different network node apparatuses, such as network system 100.

FIG. 1 provides an example and is merely illustrative of a network system 100 and a UE 150. Persons skilled in the art will understand that the network system 100 includes components not illustrated in FIG. 1 and will understand that other user equipment apparatuses may be in communication with the network system 100.

Referring now to FIG. 2, there is shown a block diagram of example components of a UE or a network apparatus. The apparatus includes an electronic storage 210, a processor 220, a memory 250, and a network interface 240. The various components may be communicatively coupled with each other. The processor 220 may be and may include any type of processor, such as a single-core central processing unit (CPU), a multi-core CPU, a microprocessor, a digital signal processor (DSP), a System-on-Chip (SoC), or any other type of processor. The memory 250 may be a volatile type of memory, e.g., RAM, or a non-volatile type of memory, e.g., NAND flash memory. The memory 250 includes processor-readable instructions that are executable by the processor 220 to cause the apparatus to perform various operations, including the mentioned herein.

The electronic storage 210 may be and include any type of electronic storage used for storing data, such as hard disk drive, solid state drive, and/or optical disc, among other types of electronic storage. The electronic storage 210 stores processor-readable instructions for causing the apparatus to perform its operations and stores data associated with such operations, such as storing data relating to 5G NR standards, among other data. The network interface 240 may implement wireless networking technologies such as 5G NR, Wi-Fi 6, and/or other wireless networking technologies.

The components shown in FIG. 2 are merely examples, and persons skilled in the art will understand that an apparatus includes other components not illustrated and may include multiples of any of the illustrated components. Such and other embodiments are contemplated to be within the scope of the present disclosure.

In accordance with aspects of the present disclosure, the apparatus of FIG. 2 implements one or more machine learning (ML) models (e.g., neural network, decision tree, etc.) and/or implements training of one or more ML models configured to implement various wireless networking features. In embodiments, the ML model(s) may be or include classical ML models (e.g., ML models that involve feature engineering). In embodiments, the ML model(s) may be or include deep neural networks, such as convolutional neural networks and/or recurrent neural networks, among others. The training of the ML model(s) includes supervised training, which persons skilled in the art will understand.

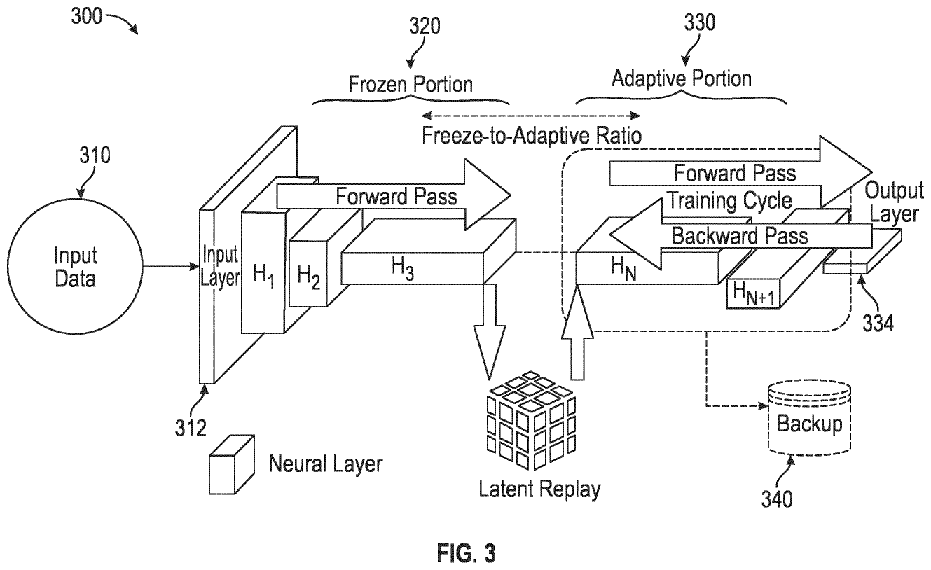

In accordance with aspects of the present disclosure, the training of the ML model(s) uses what is referred to herein as “stateful training,” which means and includes training/retraining that is performed over time for the same ML model architecture and the same input feature space, using new data as it becomes available, without training the ML model from scratch. Stateful training may be characterized as “fine-tuning” an ML model because the ML model architecture, input feature space, and designated task, are not changed. Stateful learning may also be characterized as performing “data iterations” because stateful learning builds upon previously learned knowledge using new data. The terms “fine-tuning” and “data iteration” may be used interchangeably herein to refer to a stateful training operation. Using stateful learning, an ML model is usable after each data iteration, which will be described in more detail in connection with FIG. 3. The terms “training” and “retraining” may be used interchangeably herein to refer to one or more such data iterations, unless the context indicates otherwise.

In embodiments, the timing and frequency of each data iteration operation may vary and may be configurable. In embodiments, various data iterations may be performed in an “offline” manner in the sense that the ML model is trained based on previously collected data and the trained ML model is used later; i.e., the training and use not in real-time or near real-time. In embodiments, various data iterations may be performed in an “online” manner in the sense that the ML model is trained and the trained ML model is used in real-time or near real-time as new training data becomes available. The terms “real time” and “near real-time” are context-dependent, and persons skilled in the art will recognize and understand “real time” and “non real-time” in any particular context.

The following description will illustrate and describe a neural network as an example of a machine learning model usable in accordance with aspects of the present disclosure. However, it is intended for the present disclosure to apply to other types of machine learning models as well (e.g., decision trees, etc.). Accordingly, any description herein referring to a neural network shall be treated as though such description refers to other types of ML models, as well.

Referring now to FIG. 3, there is shown an example of a ML model 300 depicted as a neural network. In embodiments, the ML model 300 may be implemented in a wireless network system (e.g., 100, FIG. 1). In the case of 5G NR network, the ML model 300 may be implemented in a gNB and/or in a network core 5GC, among other portions of a wireless network. In embodiments, the ML model 300 may be implemented in a UE (e.g., 150, FIG. 1). In FIG. 3, the illustrated ML model 300 is already trained, such as by supervised learning, and is usable. As new training data becomes available, the ML model 300 may be trained by a stateful training data iteration. In embodiments, the new training data may be labelled data and the data iteration may utilize supervised training.

In accordance with aspects of the present disclosure, the ML model 300 is configured to have a “frozen portion” 320 that is not further trained and have an “adaptive portion” 330 that is to be trained in data iterations. In accordance with aspects of the present disclosure, the boundary between the frozen portion 320 and the adaptive portion 330 is adjustable and may be specified by an adjustable “freeze-to-adaptive ratio.” In the case of a neural network, the freeze-to-adaptive ratio may indicate a ratio of number of hidden layers for the frozen portion 320 to number of hidden layers for the adaptive portion 330, or a ratio of number of hyperparameters for the frozen portion 320 to number of hyperparameters for the adaptive portion 330, among other possibilities. For example, as shown in FIG. 3, the frozen portion 320 may include hidden layers H₁-Hₙ₋₁ and the adaptive portion 330 may include hidden layers Hₙ and Hₙ₊₁. This illustrated configuration is merely an example, and other configurations based on different ML models and/or based on different values of freeze-to-adaptive ratio are within the scope of the present disclosure.

To perform stateful training of the example ML model 300 shown in FIG. 3, new training input data 310 is entered to the input layer 312 and the training conducts a forward pass through the frozen portion 320 and the adaptive portion 330. As persons skilled in the art will understand, “forward pass” refers to executing the ML model 300 to compute the output layer 334 based on input data 310 at the input layer 312. In embodiments, the forward pass may implement latent replay, which persons skilled in the art will understand. In summary, latent replay is a technique that saves computational resources by storing values from one or more hidden layers of the neural network in a way that can be retrieved and used later. Then, later, rather than performing computations in the layers before the latent replay, the values stored by the latent replay can simply be retrieved and used by the subsequent layers of the neural network. The latent replay technique is merely an example of a ML model implementation. In embodiments, the ML model 300 may not use latent replay.

After the forward pass, the training conducts a backward pass through just the adaptive portion 330 to update the parameter values of the adaptive portion 330. As persons skilled in the art will understand, “backward pass” refers to computing the output error and going backwards through the neural network to update weights to reduce the output error. As mentioned above, a data iteration may utilize labelled training data and supervised training. In accordance with aspects of the present disclosure, only the weights in the adaptive portion 330 are updated during the backward pass, while the weights in the frozen portion 320 remain unchanged. Persons skilled in the art will understand how to implement backward pass.

In the approach of FIG. 3, the freeze-to-adaptive ratio for the ML model 300 may be adjusted as appropriate. In embodiments, the freeze-to-adaptive ratio may be adjusted to decrease the number of layers in the adaptive portion 330 if, for example, only minor performance adjustments are desired for the ML model 300. In embodiments, the freeze-to-adaptive ratio may be adjusted to increase the number of layers in the adaptive portion 330 if, for example, greater performance adjustments are desired for the ML model 300. The freeze-to-adaptive ratio may be adjusted for other considerations. In embodiments, the freeze-to-adaptive ratio may be adjusted to decrease the number of layers in the adaptive portion 330 if, for example, the apparatus performing the stateful training is more resource-limited (e.g., UE 150, FIG. 1). The freeze-to-adaptive ratio may be adjusted for such and other considerations. In embodiments, adjustment of the freeze-to-adaptive ratio may be controlled in various ways, such as by heuristic rules, by control algorithms (e.g., proportional-integral-derivative control), and/or by a ML model configured to control the freeze-to-adaptive ratio (e.g., configured by reinforcement learning), among others. Such and other embodiments are contemplated to be within the scope of the present disclosure

With continuing reference to FIG. 3, and as mentioned above, the ML model 300 may be implemented in a wireless network and may be configured to implement various wireless networking features. Examples for 5G NR include, without limitation, implementing the ML model 300 to perform beam prediction, perform reference signal receive power (RSRP) prediction, and/or perform handover procedures, among others. In wireless networking, context for wireless networking devices may change frequently or even continuously, and frequent (or even continual) stateful training may be beneficial in line with the context changes. In various situations, context may change so quickly that a data iteration yields a ML model 300 that has poorer performance than before the data iteration. Other situations may also result in poorer performance after a data iteration trains the adaptive portion 330 of the ML model 300.

In accordance with aspects of the present disclosure, the ML model 300 of FIG. 3 is configured to be in communication with a backup storage device 340 to back up parameters of the adaptive portion 330 of an ML model 300, prior to a data iteration. Such backup of parameters may contain, for example, the weight matrices of the neural network layers within the adaptive portion 330. After the adaptive portion 330 of the ML model is retrained in a data iteration, performance of the retrained ML model may be compared to performance of the ML model prior to the data iteration. If performance of the retrained ML model is not improved after the data iteration, the adaptive portion parameters (e.g., weight matrices of neural network layers) stored in the backup storage device 340 may be restored so that the ML model 300 is restored to the configuration prior to the data iteration.

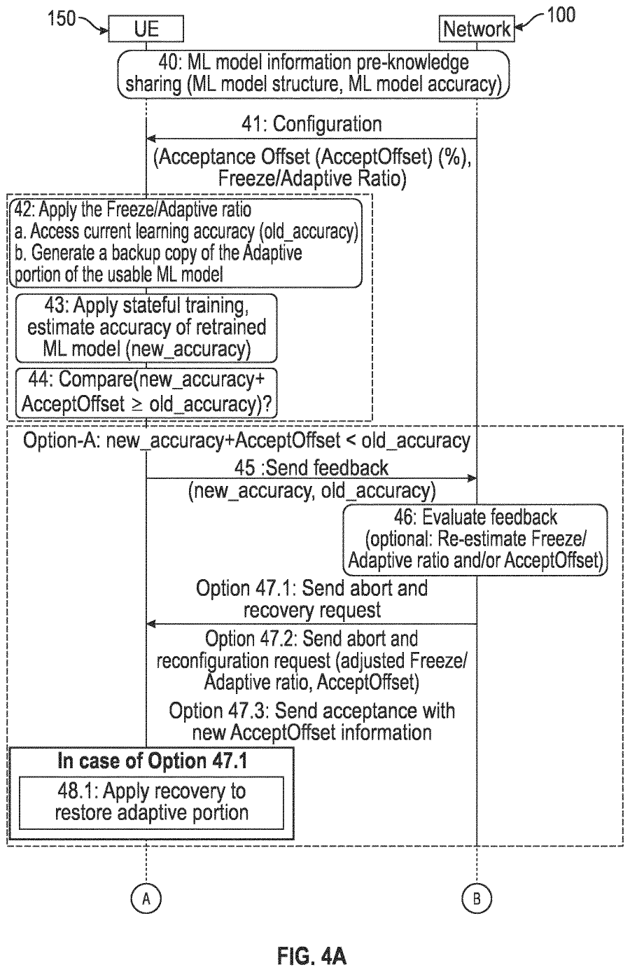

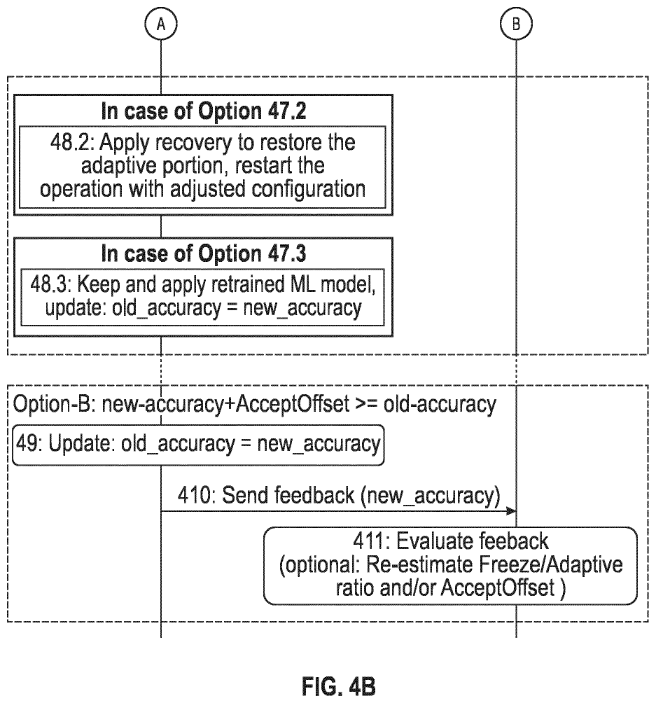

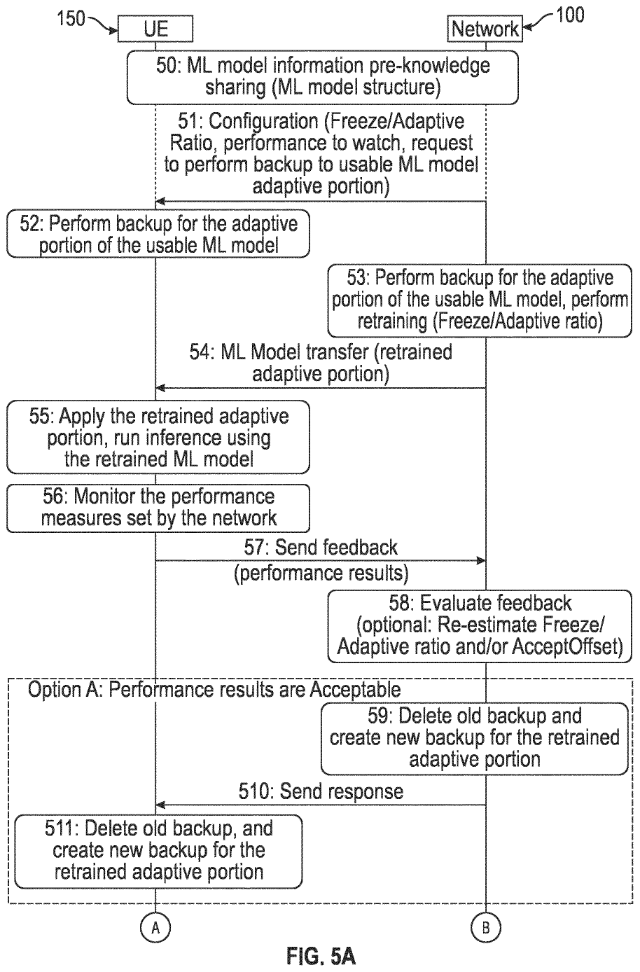

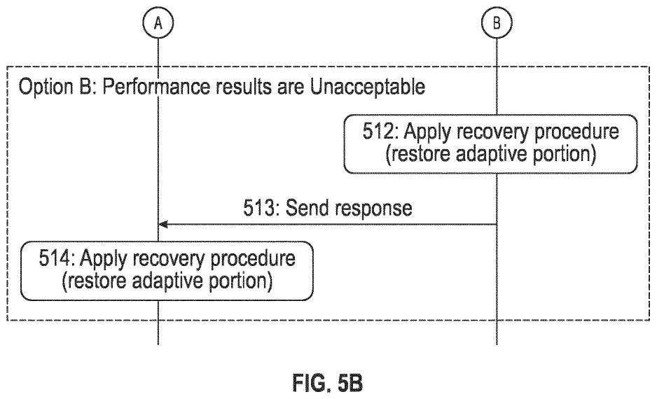

Performance of the ML model 300 may be assessed in various ways. In embodiments, performance of the ML model 300 may be assessed by ML model validation accuracy level using test or validation data, by manual user performance evaluation, and/or by system performance evaluation, among others. One or more of the assessment techniques may be used depending on where the ML model 300 is deployed, such as, in the case of a 5G NR network, in a UE (e.g., 150, FIG. 1), in the network system (e.g., 100, FIG. 1), or in both the UE and the network system (e.g., encoder-decoder ML architecture). In embodiments, a UE (e.g., 150, FIG. 1) implements the ML model 300 and executes it to perform the inference for the configured use case (e.g., beam or RSRP prediction for mobility management), regardless of whether the stateful training is executed by the UE or by the network. In embodiments, a UE (e.g., 150, FIG. 1) and/or a network system (e.g., 100, FIG. 1) may partially or wholly perform the stateful training of the ML model 300. Example implementations for 5G NR are described below in connection with FIG. 4A/4B and FIG. 5A/5B. Such examples are merely illustrative. It is intended for aspects of the present disclosure to apply to any type of wireless network.

The ML model illustrated in FIG. 3 is merely an example. Other ML models and other ML model configurations are contemplated to be within the scope of the present disclosure.

In the following description, performance of a ML model will be described using accuracy of ML model in outputting expected outputs based on known inputs. Use of model accuracy is merely illustrative, and other performance measures may be used. Accordingly, it is intended for any description referring to model accuracy to be treated as though the description referred to other performance measures, as well.

Referring now to FIGS. 4A and 4B, there is shown a flow diagram of example operations and signals for an implementation in which a UE 150 performs stateful training of a ML model (e.g., 300, FIG. 3). For operation 40, the UE 150 and the network 100 share knowledge and information regarding a ML model, such as knowledge and information regarding parameters and accuracy of the ML model. In embodiments, the parameters may include, for example, weight matrices of neural network layers. The ML model shared in operation 40 will be referred to as a usable ML model. In embodiments, the usable ML model is stored in the UE 150, where it is trained and used, and optionally, may also be stored in the network 100. In embodiments, the usable ML model may be a neural network, such as the neural network shown in FIG. 3, which may be already trained by supervised learning. In embodiments, the accuracy of the usable ML model can be determined using validation test data. The weights and accuracy of the neural network may be shared between the UE 150 and the network 100. Operation 40 may be a procedure for exchanging a UE's ML capabilities with the network 100. In embodiments, operation 40 can be performed at initial access to the network, RRC connection setup, and/or according to vendor knowledge information sharing with the network 100.

For signal 41, the network 100 transmits a configuration message to the UE 150, and the UE 150 receives the configuration message from the network 100. The configuration message may contain, for example, a freeze-to-adaptive ratio value and an acceptance offset value. The freeze-to-adaptive ratio is the freeze-to-adaptive ratio explained above herein. The acceptance offset value is a mechanism for saving processing resources in case a retrained ML model performs worse but still performs acceptably. For example, for an acceptance offset value of 1%, a retrained ML model may be maintained so long as its accuracy level does not drop more than 1% below the accuracy level of the usable ML model. Stated another way, if accuracy of the usable ML model is denoted as old_accuracy, accuracy of a retrained ML model is denoted as new_accuracy, and the acceptance offset value is denoted as AcceptOffset, then the retrained ML model will be maintained so long as (new_accuracy+AcceptOffset≥old_accuracy). The acceptance offset value is a recognition that that accuracy of a retrained ML model may still be acceptable even if it drops slightly, and so long as accuracy is acceptable, resources do not need to be spent to restore the backup of the adaptive portion of the stored ML model. In embodiments, the acceptance offset value may be 0, which indicates that stateful training must maintain or improve performance for a retrained ML model to be maintained.

For operation 42, the UE 150 applies the freeze-to-adaptive ratio value by determining, based on the freeze-to-adaptive ratio value, a frozen portion of the usable ML model to not train and an adaptive portion of the usable ML model to further train. For example, as described in connection with FIG. 3, the frozen portion may include a particular number of hidden layers or hyperparameters, and the adaptive portion may include the remaining hidden layers or hyperparameters. For operation 42a, the UE 150 accesses the accuracy of the usable ML model, which was exchanged in operation 40. For operation 42b, the UE 150 generates a backup of the adaptive portion of usable ML model, which may include backing up weight matrices of layers of a neural network.

For operation 43, the UE 150 applies stateful training based on new training data. The adaptive portion of the usable ML model is retrained using the new training data and, together with the frozen portion, forms a retrained ML model. For operation 43, the UE 150 estimates the accuracy of the retrained ML model. In embodiments, the UE 150 may estimate the accuracy of the retrained ML model using validation data, which may quickly estimate the accuracy of the retrained ML model. In embodiments, the UE 150 may estimate the accuracy of the retrained ML model using user feedback over time and/or using system evaluation over time. Such evaluations over time are not as quick as estimating accuracy using validation data but may provide beneficial information.

For operation 44, the UE 150 compares the accuracy of the retrained ML model with the accuracy of the usable ML model to determine whether accuracy of the retrained ML model is acceptable. In embodiments, the UE 150 applies an acceptance offset value in the comparison in the manner described above herein. In embodiments, if accuracy of the usable ML model is denoted as old_accuracy, accuracy of a retrained ML model is denoted as new_accuracy, and the acceptance offset value is denoted as AcceptOffset, then operation 44 may determine whether (new_accuracy+AcceptOffset≥old_accuracy). In embodiments, AcceptOffset may be 0.

If operation 44 determines that accuracy of the retrained ML model is acceptable (e.g., new_accuracy+AcceptOffset≥old_accuracy), then there is no need to restore the backup of the adaptive portion of the usable ML model. The retrained ML model is treated as the usable ML model, and the signals and operations 49-411 are performed. At operation 49, the value of old_accuracy is set to the value of new_accuracy based on the retrained ML model becoming the usable ML model. At signal 410, the UE 150 transmits a feedback signal to the network 100 indicating that the retrained ML model is acceptable. In embodiments, the signal 410 may include the new_accuracy value. For operation 411, the network 100 evaluates the indication that the retrained ML model is acceptable and may optionally adjust the freeze-to-adaptive ratio and/or the acceptance offset value.

If operation 44 determines that accuracy of the retrained ML model is unacceptable (e.g., new_accuracy+AcceptOffset<old_accuracy), the signals and operations 45-48.3 are performed. For signal 45, the UE 150 transmits a feedback signal 45 to the network 100 indicating that the retrained ML model is unacceptable. In embodiments, the signal 45 may include the new_accuracy value and the old_accuracy value. For operation 46, the network 100 evaluates the indication that the retrained ML model is unacceptable and may adjust the freeze-to-adaptive ratio and/or the acceptance offset value. For operation 46, the network 100 may determine the extent of the retrained ML model's unacceptable performance (e.g., size of difference between (new_accuracy+AcceptOffset) and old_accuracy). In embodiments, if the difference is relatively small, then the value of the acceptance offset may be adjusted. In embodiments, if the different is relatively large, the freeze-to-adaptive ratio may be adjusted. The network 100 may transmit one of signals 47.1, 47.2, or 47.3 to the UE 150, and the UE 150 may perform, repectively, operations 48.1, 48.2, or 48.3, in response to such signals. In embodiments, signal 47.3 and operation 48.3 may be used in a case where the difference between (new_accuracy+AcceptOffset) and old_accuracy is very small.

For signal 47.1, the network 100 transmits an abort and recovery request signal 47.1 instructing the UE 150 to restore the backup of the adaptive portion of the usable ML model, and the UE 150 receives the signal 47.1. For operation 48.1, the UE 150 restores the backup of the adaptive portion of the usable ML model, which reverts the retrained ML model back to the usable ML model.

For signal 47.2, the network 100 transmits an abort and reconfiguration request signal 47.2 instructing the UE 150 to restore the backup of the adaptive portion of the usable ML model and to perform stateful learning again with an adjusted AcceptOffset value and/or an adjusted freeze-to-offset value, and the UE 150 receives the signal 47.2. For operation 48.2, the UE 150 restores the backup of the adaptive portion of the usable ML model, which reverts the retrained ML model back to the usable ML model, and performs stateful learning again with the adjusted AcceptOffset value and/or the adjusted freeze-to-offset value.

For signal 47.3, the network 100 transmits an acceptance signal 47.3 instructing the UE 150 to accept the retrained ML model and to perform stateful learning again with an adjusted AcceptOffset value, and the UE 150 receives the signal 47.3. As mentioned above, signal 47.3 and operation 48.3 may be used in a case where the difference between (new_accuracy+AcceptOffset) and old_accuracy is very small. For operation 48.3, the retrained ML model becomes the usable ML model, the UE 150 generates a backup of the adaptive portion of the usable ML model, and the UE 150 performs stateful learning again with the adjusted AcceptOffset value received from the network 100.

The signals and operations of FIGS. 4A and 4B are merely examples, and variations are contemplated to be within the scope of the present disclosure. In embodiments, signals and operations not shown in FIGS. 4A and 4B may be included. In embodiments, one or more of the signals and operations shown in FIGS. 4A and 4B may be excluded. In embodiments, the signals and operations shown in FIGS. 4A and 4B may be performed in a different order. In embodiments, the network 100 may transmit in signal 51 a timer and/or counter that could be automatically used by the UE 150 to stop stateful training and to restore the backup in case the stateful training and validation process are not able to satisfy (new_accuracy+AcceptOffset≥old_accuracy). Such and other embodiments are contemplated to be within the scope of the present disclosure.

Referring now to FIGS. 5A and 5B, there is shown a flow diagram of example operations and signals for an implementation in which a network system 100 performs stateful training of a ML model. For operation 50, the UE 150 and the network 100 share knowledge and information regarding a ML model, such as knowledge and information regarding the ML model architecture. The ML model shared in operation 50 will be referred to as a usable ML model. In embodiments, the usable ML model is stored in the network 100, where it is trained, and is stored in the UE 150, where it is used. In embodiments, the usable ML model may be a neural network, such as the neural network shown in FIG. 3, which may already be trained by supervised learning. The weights of the neural network may be shared between the network 100 and the UE 150. Operation 50 may be a procedure for exchanging a UE's ML capabilities with the network 100.

For signal 51, the network 100 transmits a configuration message to the UE 150, and the UE 150 receives the configuration message from the network 100. The configuration message may contain, for example, a freeze-to-adaptive ratio value and/or an acceptance offset value. The freeze-to-adaptive ratio and the acceptance offset value were described above herein. The network 100 may transmit the freeze-to-adaptive ratio to the UE 150 so the UE 150 may understand which part of the usable ML model will be frozen and which part will be adaptive and will be backed up. In embodiments, the signal 51 may include a request for the UE 150 to perform a backup of the adaptive portion of the usable ML model. In embodiments, the signal 51 may include information regarding performance measures for the UE 150 to monitor as it executes the usable ML model. The performance measures may include, for example, at least one of: number of beam failures, number of radio link failures, number of ping-pongs, and/or Time in Outage (low SINR levels), among others. In embodiments, the signal 51 may include information about data for the UE 150 to collect, such as information to be used for ground truth/training data labels, among other data.

For operation 52, the UE 150 performs a backup of the adaptive portion of the usable ML model. For operation 53, the network 100 performs a backup of the adaptive portion of the usable ML model and performs stateful training of the adaptive portion of the usable ML model. The retrained adaptive portion, together with the frozen portion of the usable ML model, together form a retrained ML model.

For signal 54, the network 100 transmits parameters of the retrained adaptive portion to the UE 150, and the UE 150 receives the signal 54. In embodiments, the parameters may include weight matrices of neural network layers.

For operation 55, the UE 150 applies to the parameters of the retrained adaptive portion to form the retrained ML model at the UE 150, and the UE 150 executes the retrained ML model to perform an inference.

For operation 56, the UE 150 monitors the performance measures indicated by the network in signal 51 and gathers data for the performance measures. In embodiments, the UE 150 may run tests and collect data to estimate accuracy of the retrained ML model.

For signal 57, the UE 150 transmits the collected performance measures and accuracy results as a feedback message to the network 100, and the network 100 receives signal 57. In embodiments, the UE 150 may transmit signal 57 as a scheduled signal based on a timer or may transmit signal 57 in response to a separate request message from the network 100 (not shown).

For operation 58, the network 100 evaluates whether the performance measures are acceptable and may optionally adjust the freeze-to-adaptive ratio value and/or the acceptance offset value.

If operation 58 determines that the performance measures are acceptable, then there is no need to restore the backup of the adaptive portion of the usable ML model, and the signals and operations 59-511 are performed. At operation 59, at the network 100, the backup of the adaptive portion of the usable ML model is deleted, the retrained ML model is treated as the usable ML model, and a new backup of the adaptive portion of the retrained ML model is generated. At signal 510, the network 100 transmits a response signal to the UE 150 indicating that the retrained ML model is acceptable, and the UE 150 receives signal 510. For operation 511, at the UE 150, the backup of the adaptive portion of the usable ML model is deleted, the retrained ML model is treated as the usable ML model, and a new backup of the adaptive portion of the retrained ML model is generated.

If operation 58 determines that the performance measures are unacceptable, then the backup of the adaptive portion of the usable ML model will need to be restored, and the signals and operations 512-514 are performed. For operation 512, the network 100 restores the backup of the adaptive portion of the usable ML model, which reverts the trained ML model back to the usable ML model at the network 100. For signal 513, the network 100 transmits a response signal instructing the UE 150 to restore the backup of the adaptive portion of the usable ML model, and the UE 150 receives the signal 513. For operation 514, the UE 150 restores the backup of the adaptive portion of the usable ML model, which reverts the retrained ML model back to the usable ML model at the UE 150.

The signals and operations of FIGS. 5A and 5B are merely examples, and variations are contemplated to be within the scope of the present disclosure. In embodiments, signals and operations not shown in FIGS. 5A and 5B may be included. In embodiments, one or more of the signals and operations shown in FIGS. 5A and 5B may be excluded. In embodiments, the signals and operations shown in FIGS. 5A and 5B may be performed in a different order. Such and other embodiments are contemplated to be within the scope of the present disclosure.

Further embodiments of the present disclosure include the following examples.

Example 1. A method comprising:
accessing a usable machine learning (ML) model, the usable ML model comprising a frozen portion of the usable ML model to not train and an adaptive portion of the usable ML model to train;
generating a backup of the adaptive portion of the usable ML model;
retrain the adaptive portion of the usable ML model to provide a retrained adaptive portion; and transmitting parameters of the retrained adaptive portion to a user equipment apparatus for use by the user equipment apparatus.

Example 2. The method of Example 1, further comprising:
receiving, from the user equipment apparatus, a performance measure indicating performance of the retrained adaptive portion; and
determining whether or not to restore the backup of the adaptive portion of the current ML model based on the performance measure indicating performance of the retrained adaptive portion.

Example 3. The method of Example 2, further comprising:
transmitting, to the user equipment apparatus, the freeze-to-adaptive ratio to enable the user equipment apparatus to generate, at the user equipment apparatus, a local backup of the adaptive portion of the current ML model.

Example 4. The method of Example 3, further comprising, in case of determining to restore the backup of the adaptive portion of the usable ML model:
restoring the backup of the adaptive portion of the usable ML model; and
transmitting, to the user equipment apparatus, an instruction to restore, at the user equipment apparatus, the local backup of the adaptive portion of the usable ML model.

Example 5. The method of Example 3, further comprising, in case of determining not to restore the backup of the adaptive portion of the usable ML model:
deleting the backup of the adaptive portion of the usable ML model;
generating a backup of the retrained adaptive portion; and
transmitting, to the user equipment apparatus, an instruction to, at the user equipment apparatus, delete the local backup of the adaptive portion of the usable ML model and create a local backup of the retrained adaptive portion.

Example 6. A user equipment apparatus comprising:
at least one processor; and
at least one memory storing instructions which, when executed by the at least one processor, cause the user equipment apparatus at least to:
access a usable machine learning (ML) model;
receive, from a network apparatus, a freeze-to-adaptive ratio value;
determine, based on the freeze-to-adaptive ratio, a frozen portion of the usable ML model and an adaptive portion of the usable ML model;
generate a backup of the adaptive portion of the usable ML model;
receive parameters of a retrained adaptive portion from the network apparatus;
combine the frozen portion of the usable ML model and the retrained adaptive portion to form a retrained ML model; and
use the retrained ML model.

Example 7. The user equipment apparatus of Example 6, wherein the instructions, when executed by the at least one processor, further cause the user equipment apparatus at least to:
determine a performance measure for the retrained ML model; and
transmit the performance measure to the network apparatus.

Example 8. The user equipment apparatus of Example 7, wherein the instructions, when executed by the at least one processor, further cause the user equipment apparatus at least to:
receive, from the network apparatus, an indication that performance of the retrained ML model is acceptable; and
in response to the indication:
delete the backup of the adaptive portion of the usable ML model, and
generate a backup of the adaptive portion of the retrained ML model.

Example 9. The user equipment apparatus of Example 7, wherein the instructions, when executed by the at least one processor, further cause the user equipment apparatus at least to:
receive, from the network apparatus, an indication that performance of the retrained ML model is unacceptable; and
in response to the indication, restore the backup of the adaptive portion of the usable ML model.

Example 10. A method comprising:
accessing a usable machine learning (ML) model;
receiving, from a network apparatus, a freeze-to-adaptive ratio value;
determining, based on the freeze-to-adaptive ratio, a frozen portion of the usable ML model and an adaptive portion of the usable ML model;
generating a backup of the adaptive portion of the usable ML model;
receiving parameters of a retrained adaptive portion from the network apparatus;
combining the frozen portion of the usable ML model and the retrained adaptive portion to form a retrained ML model; and
using the retrained ML model.

Example 11. The method of Example 10, further comprising: determining a performance measure for the retrained ML model; and transmitting the performance measure to the network apparatus.

Example 12. The method of Example 11, further comprising: receiving, from the network apparatus, an indication that performance of the retrained ML model is acceptable; and in response to the indication: deleting the backup of the adaptive portion of the usable ML model, and generating a backup of the adaptive portion of the retrained ML model.

Example 13. The user equipment apparatus of Example 11, further comprising: receiving, from the network apparatus, an indication that performance of the retrained ML model is unacceptable; and in response to the indication, restoring the backup of the adaptive portion of the usable ML model.

Example 14. A user equipment apparatus comprising:
means for accessing a usable machine learning (ML) model;
means for receiving, from a network apparatus, a freeze-to-adaptive ratio value;
means for determining, based on the freeze-to-adaptive ratio, a frozen portion of the usable ML model to not train and an adaptive portion of the usable ML model to train;
means for accessing a performance measure for the usable ML model;
means for retraining the adaptive portion of the usable ML model to provide a retrained ML model;
means for determining a performance measure for the retrained ML model; and
means for selecting one of the retrained ML model or the usable ML model based on the performance measure of the usable ML model and the performance measure of the retrained ML model.

Example 15. The user equipment apparatus of Example 14, further comprising:
means for receiving, from a network apparatus, an acceptance offset value; and
means for offsetting the performance measure for the retrained ML model by the acceptance offset value to generate an offset performance measure for the retained ML model.

Example 16. The user equipment apparatus of Example 15, further comprising:
means for, in case the offset performance measure for the retrained ML model is greater than or equal to the performance measure for the usable ML model, transmitting to the network apparatus an indication of acceptable performance of the retrained ML model.

Example 17. The user equipment apparatus of Example 16, wherein the indication of acceptable performance of the retrained ML model is transmitted in a case where the performance measure for the retrained ML model is less than the performance measure for the usable ML model by less than the acceptance offset value.

Example 18. The user equipment apparatus of Example 15, further comprising:
means for, in case the offset performance measure for the retrained ML model is less than the performance measure for the usable ML model, transmitting to the network apparatus an indication of unacceptable performance of the retrained ML model.

Example 19. The user equipment apparatus of any one of Examples 14-18, further comprising:
means for, prior to retraining the adaptive portion of the usable ML model, generating a backup of the adaptive portion of the usable ML model.

Example 20. The user equipment apparatus of Example 19, further comprising:
means for, in response to a request from the network apparatus, restoring the adaptive portion of the usable ML model using the backup of the adaptive portion of the ML model.

Example 21. The user equipment apparatus of any one of Examples 14-20, further comprising:
means for receiving, from the network apparatus, at least an adjusted freeze-to-adaptive ratio; and
means for retraining an adjusted adaptive portion of the usable ML model based on the adjusted freeze-to-adaptive ratio.

Example 22. A network apparatus comprising:
means for accessing a usable machine learning (ML) model, the usable ML model comprising a frozen portion of the usable ML model to not train and an adaptive portion of the usable ML model to train;
means for generating a backup of the adaptive portion of the usable ML model;
means for retraining the adaptive portion of the usable ML model to provide a retrained adaptive portion; and
means for transmitting parameters of the retrained adaptive portion to a user equipment apparatus for use by the user equipment apparatus.

Example 23. The network apparatus of Example 22, further comprising:
means for receiving, from the user equipment apparatus, a performance measure indicating performance of the retrained adaptive portion; and
means for determining whether or not to restore the backup of the adaptive portion of the usable ML model based on the performance measure indicating performance of the retrained adaptive portion.

Example 24. The network apparatus of Example 23, further comprising:
means for transmitting, to the user equipment apparatus, the freeze-to-adaptive ratio to enable the user equipment apparatus to generate, at the user equipment apparatus, a local backup of the adaptive portion of the usable ML model.

Example 25. The network apparatus of Example 24, further comprising:
in case of determining to restore the backup of the adaptive portion of the usable ML model:
means for restoring the backup of the adaptive portion of the usable ML model; and
means for transmitting, to the user equipment apparatus, an instruction to restore, at the user equipment apparatus, the local backup of the adaptive portion of the usable ML model.

Example 26. The network apparatus of Example 24, wherein the instructions, when executed by the at least one processor, further cause the network apparatus at least to:
in case of determining not to restore the backup of the adaptive portion of the usable ML model:
means for deleting the backup of the adaptive portion of the usable ML model;
means for generating a backup of the retrained adaptive portion; and
means for transmitting, to the user equipment apparatus, an instruction to, at the user equipment apparatus, delete the local backup of the adaptive portion of the usable ML model and create a local backup of the retrained adaptive portion.

Example 27. A user equipment apparatus comprising:
means for accessing a usable machine learning (ML) model;
means for receiving, from a network apparatus, a freeze-to-adaptive ratio value;
means for determining, based on the freeze-to-adaptive ratio, a frozen portion of the usable ML model and an adaptive portion of the usable ML model;
means for generating a backup of the adaptive portion of the usable ML model;
means for receiving parameters of a retrained adaptive portion from the network apparatus;
means for combining the frozen portion of the usable ML model and the retrained adaptive portion to form a retrained ML model; and
means for using the retrained ML model.

Example 28. The user equipment apparatus of Example 27, further comprising:
means for determining a performance measure for the retrained ML model; and
means for transmitting the performance measure to the network apparatus.

Example 29. The user equipment apparatus of Example 28, further comprising:
means for receiving, from the network apparatus, an indication that performance of the retrained ML model is acceptable; and
in response to the indication:
means for deleting the backup of the adaptive portion of the usable ML model, and
means for generating a backup of the adaptive portion of the retrained ML model.

Example 30. The user equipment apparatus of Example 28, further comprising:
means for receiving, from the network apparatus, an indication that performance of the retrained ML model is unacceptable; and
means for, in response to the indication, restoring the backup of the adaptive portion of the usable ML model.

The embodiments and aspects disclosed herein are examples of the disclosure and may be embodied in various forms. For instance, although certain embodiments herein are described as separate embodiments, each of the embodiments herein may be combined with one or more of the other embodiments herein. Specific structural and functional details disclosed herein are not to be interpreted as limiting, but as a basis for the claims and as a representative basis for teaching one skilled in the art to variously employ the present disclosure in virtually any appropriately detailed structure. Like reference numerals may refer to similar or identical elements throughout the description of the figures.

The phrases “in an aspect,” “in aspects,” “in various aspects,” “in some aspects,” or “in other aspects” may each refer to one or more of the same or different aspects in accordance with this disclosure. The phrase “a plurality of” may refer to two or more.

The phrases “in an embodiment,” “in embodiments,” “in various embodiments,” “in some embodiments,” or “in other embodiments” may each refer to one or more of the same or different embodiments in accordance with the present disclosure. A phrase in the form “A or B” means “(A), (B), or (A and B).” A phrase in the form “at least one of A, B, or C” means “(A); (B); (C); (A and B); (A and C); (B and C); or (A, B, and C).”

Any of the herein described methods, programs, algorithms or codes may be converted to, or expressed in, a programming language or computer program. The terms “programming language” and “computer program,” as used herein, each include any language used to specify instructions to a computer or processor, and include (but is not limited to) the following languages and their derivatives: Assembler, Basic, Batch files, BCPL, C, C+, C++, Delphi, Fortran, Java, JavaScript, machine code, operating system command languages, Pascal, Perl, PL1, Python, scripting languages, Visual Basic, metalanguages which themselves specify programs, and all first, second, third, fourth, fifth, or further generation computer languages. Also included are database and other data schemas, and any other meta-languages. No distinction is made between languages which are interpreted, compiled, or use both compiled and interpreted approaches. No distinction is made between compiled and source versions of a program. Thus, reference to a program, where the programming language could exist in more than one state (such as source, compiled, object, or linked) is a reference to any and all such states. Reference to a program may encompass the actual instructions and/or the intent of those instructions.

While aspects of the disclosure have been shown in the drawings, it is not intended that the disclosure be limited thereto, as it is intended that the disclosure be as broad in scope as the art will allow and that the specification be read likewise. Therefore, the above description should not be construed as limiting, but merely as exemplifications of particular aspects. Those skilled in the art will envision other modifications within the scope and spirit of the claims appended hereto.

1-21. (canceled)

22. A user equipment apparatus comprising:
at least one processor; and
at least one memory storing instructions which, when executed by the at least one processor, cause the user equipment apparatus at least to:
access a usable machine learning (ML) model;
receive, from a network apparatus, a freeze-to-adaptive ratio value;
determine, based on the freeze-to-adaptive ratio, a frozen portion of the usable ML model to not train and an adaptive portion of the usable ML model to train;
access a performance measure for the usable ML model;
retrain the adaptive portion of the usable ML model to provide a retrained ML model;
determine a performance measure for the retrained ML model; and
select one of the retrained ML model or the usable ML model based on the performance measure of the usable ML model and the performance measure of the retrained ML model.

23. The user equipment apparatus of claim 22, wherein the instructions, when executed by the at least one processor, further cause the user equipment apparatus at least to:
receive, from a network apparatus, an acceptance offset value; and
offset the performance measure for the retrained ML model by the acceptance offset value to generate an offset performance measure for the retained ML model.

24. The user equipment apparatus of claim 22, wherein the instructions, when executed by the at least one processor, further cause the user equipment apparatus at least to:
receive, from a network apparatus, an acceptance offset value;
offset the performance measure for the retrained ML model by the acceptance offset value to generate an offset performance measure for the retained ML model, and
in case the offset performance measure for the retrained ML model is greater than or equal to the performance measure for the usable ML model, transmit to the network apparatus an indication of acceptable performance of the retrained ML model.

25. The user equipment apparatus of claim 22, wherein the instructions, when executed by the at least one processor, further cause the user equipment apparatus at least to:
receive, from a network apparatus, an acceptance offset value;
offset the performance measure for the retrained ML model by the acceptance offset value to generate an offset performance measure for the retained ML model, and
in case the offset performance measure for the retrained ML model is greater than or equal to the performance measure for the usable ML model, transmit to the network apparatus an indication of acceptable performance of the retrained ML model, and wherein the indication of acceptable performance of the retrained ML model is transmitted in a case where the performance measure for the retrained ML model is less than the performance measure for the usable ML model by less than the acceptance offset value.

26. The user equipment apparatus of claim 22, wherein the instructions, when executed by the at least one processor, further cause the user equipment apparatus at least to:
receive, from a network apparatus, an acceptance offset value;
offset the performance measure for the retrained ML model by the acceptance offset value to generate an offset performance measure for the retained ML model, and
in case the offset performance measure for the retrained ML model is less than the performance measure for the usable ML model, transmit to the network apparatus an indication of unacceptable performance of the retrained ML model.

27. The user equipment apparatus of claim 22, wherein the instructions, when executed by the at least one processor, further cause the user equipment apparatus at least to:
prior to retraining the adaptive portion of the usable ML model, generate a backup of the adaptive portion of the usable ML model.

28. The user equipment apparatus of claim 22, wherein the instructions, when executed by the at least one processor, further cause the user equipment apparatus at least to:
prior to retraining the adaptive portion of the usable ML model, generate a backup of the adaptive portion of the usable ML model, and
in response to a request from the network apparatus, restore the adaptive portion of the usable ML model using the backup of the adaptive portion of the ML model.

29. The user equipment apparatus of claim 22, wherein the instructions, when executed by the at least one processor, further cause the user equipment apparatus at least to:
receive, from the network apparatus, at least an adjusted freeze-to-adaptive ratio; and
retrain an adjusted adaptive portion of the usable ML model based on the adjusted freeze-to-adaptive ratio.

30. A method comprising:
accessing a usable machine learning (ML) model;
receiving, from a network apparatus, a freeze-to-adaptive ratio value;
determining, based on the freeze-to-adaptive ratio, a frozen portion of the usable ML model to not train and an adaptive portion of the usable ML model to train;
accessing a performance measure for the usable ML model;
retraining the adaptive portion of the usable ML model to provide a retrained ML model;
determining a performance measure for the retrained ML model; and
selecting one of the retrained ML model or the usable ML model based on comparing the performance measure of the usable ML model and the performance measure of the retrained ML model.

31. The method of claim 30, further comprising:
receiving, from a network apparatus, an acceptance offset value; and
offsetting the performance measure for the retrained ML model by the acceptance offset value to generate an offset performance measure for the retained ML model.

32. The method of claim 30, further comprising:
receiving, from a network apparatus, an acceptance offset value; and
offsetting the performance measure for the retrained ML model by the acceptance offset value to generate an offset performance measure for the retained ML model, and
in case the offset performance measure for the retrained ML model is greater than or equal to the performance measure for the usable ML model, transmitting to the network apparatus an indication of acceptable performance of the retrained ML model.

33. The method of claim 30, further comprising:
receiving, from a network apparatus, an acceptance offset value; and
offsetting the performance measure for the retrained ML model by the acceptance offset value to generate an offset performance measure for the retained ML model, and
in case the offset performance measure for the retrained ML model is less than the performance measure for the usable ML model, transmitting to the network apparatus an indication of unacceptable performance of the retrained ML model.

34. The method of claim 30, further comprising:
prior to retraining the adaptive portion of the usable ML model, generating a backup of the adaptive portion of the usable ML model.

35. The method of claim 30, further comprising:
prior to retraining the adaptive portion of the usable ML model, generating a backup of the adaptive portion of the usable ML model, and
in response to a request from the network apparatus, restoring the adaptive portion of the usable ML model using the backup of the adaptive portion of the ML model.

36. The method of claim 30, further comprising:
receiving from the network apparatus at least an adjusted freeze-to-adaptive ratio; and
retraining an adjusted adaptive portion of the usable ML model based on the adjusted freeze-to-adaptive ratio.

37. A network apparatus comprising:
at least one processor; and
at least one memory storing instructions which, when executed by the at least one processor, cause the network apparatus at least to:
access a usable machine learning (ML) model, the usable ML model comprising a frozen portion of the usable ML model to not train and an adaptive portion of the usable ML model to train;
generate a backup of the adaptive portion of the usable ML model;
retrain the adaptive portion of the usable ML model to provide a retrained adaptive portion; and
transmit parameters of the retrained adaptive portion to a user equipment apparatus for use by the user equipment apparatus.

38. The network apparatus of claim 37, wherein the instructions, when executed by the at least one processor, further cause the network apparatus at least to:
receive, from the user equipment apparatus, a performance measure indicating performance of the retrained adaptive portion; and
determine whether or not to restore the backup of the adaptive portion of the usable ML model based on the performance measure indicating performance of the retrained adaptive portion.

39. The network apparatus of claim 37, wherein the instructions, when executed by the at least one processor, further cause the network apparatus at least to:
receive, from the user equipment apparatus, a performance measure indicating performance of the retrained adaptive portion;
determine whether or not to restore the backup of the adaptive portion of the usable ML model based on the performance measure indicating performance of the retrained adaptive portion, and
transmit, to the user equipment apparatus, the freeze-to-adaptive ratio to enable the user equipment apparatus to generate, at the user equipment apparatus, a local backup of the adaptive portion of the usable ML model.

40. The network apparatus of claim 37, wherein the instructions, when executed by the at least one processor, further cause the network apparatus at least to:
receive, from the user equipment apparatus, a performance measure indicating performance of the retrained adaptive portion;
determine whether or not to restore the backup of the adaptive portion of the usable ML model based on the performance measure indicating performance of the retrained adaptive portion;
transmit, to the user equipment apparatus, the freeze-to-adaptive ratio to enable the user equipment apparatus to generate, at the user equipment apparatus, a local backup of the adaptive portion of the usable ML model, and
in case of determining to restore the backup of the adaptive portion of the usable ML model:
restore the backup of the adaptive portion of the usable ML model; and
transmit, to the user equipment apparatus, an instruction to restore, at the user equipment apparatus, the local backup of the adaptive portion of the usable ML model.

41. The network apparatus of claim 37, wherein the instructions, when executed by the at least one processor, further cause the network apparatus at least to:
receive, from the user equipment apparatus, a performance measure indicating performance of the retrained adaptive portion;
determine whether or not to restore the backup of the adaptive portion of the usable ML model based on the performance measure indicating performance of the retrained adaptive portion;
transmit, to the user equipment apparatus, the freeze-to-adaptive ratio to enable the user equipment apparatus to generate, at the user equipment apparatus, a local backup of the adaptive portion of the usable ML model, and
in case of determining not to restore the backup of the adaptive portion of the usable ML model:
delete the backup of the adaptive portion of the usable ML model;
generate a backup of the retrained adaptive portion; and
transmit, to the user equipment apparatus, an instruction to, at the user equipment apparatus, delete the local backup of the adaptive portion of the usable ML model and create a local backup of the retrained adaptive portion.
